(19) United States
(12) Patent Application Publication
(10) Pub. No.: US 2018/0349230 A1
(43) Pub. Date: Dec. 6, 2018

(54) CONTEXT AWARE DATA BACKUP

(71) Applicant: HEWLETT PACKARD ENTERPRISE DEVELOPMENT LP, Houston, TX (US)

(72) Inventors: Vijay Gupta Gupta, Sunnyvale, CA (US); Archana Bharathidasan, Sunnyvale, CA (US); David Earl Wiser, Sunnyvale, CA (US); Vsevolod Yakhontov, Sunnyvale, CA (US); Aditya Shukla, Sunnyvale, CA (US)

(21) Appl. No.: 15/780,341

(22) PCT Filed: Jan. 28, 2016
(86) PCT No.: PCT/US2016/015281

§ 371 Date: May 31, 2018

(51) Int. Cl. G06F 11/14

(52) U.S. Cl. CPC G06F 11/1458; G06F 2201/84; G06F 11/1451

(57) ABSTRACT

In one example in accordance with the present disclosure, a method for context aware data backup may include determining a first set of files that are altered during normal operation of a computer system and storing the first set of files at a destination location. The method may include determining a second set of files that are altered during normal operation of the computer system and determining a size difference between the first set of files and the second set of files. The method may also include determining a time difference between a first time taken to copy the first set of files and a second time taken to copy a previous set of files to the destination location. The method may include determining that the size difference and the time difference meet a threshold for backup and storing the second set of files at the destination location.

### BACKGROUND

Companies may release upgrades and/or patches to software and systems to enable features and deal with security issues. In many cases, companies recommend that users perform a full backup of software and any related data prior to upgrading.

### BRIEF DESCRIPTION OF THE DRAWINGS

The following detailed description references the drawings, wherein:

FIG. 1 is a block diagram of an example system for context aware data backup;

FIG. 2 is a flowchart of an example method for context aware data backup;

FIG. 3 is a flowchart of an example method for determining files for backup;

FIG. 4 is a block diagram of an example system for context aware data backup; and

FIG. 5 is a block diagram of an example system for context aware data backup.

### DETAILED DESCRIPTION

Many methods for backup are not sensitive to the context of the application that is being backed up. Continuing to run a computer system during a backup without an awareness of the application and data being backed up may result in inconsistent systems and/or backups, especially in high throughput applications. On the other hand, requiring that the system be down while during backup may result in system downtime running into hours, days or even weeks. When customers have a critical data system, the system downtime to perform the backup itself might be unacceptable.

The context aware data backup system discussed herein may maximize system uptime while facilitating simultaneous backup of the system. The context aware data backup system may also allow a computer system to be up and running while the majority of the backup/restore is being done. Thus, the computersystem may only be down for a fraction of the entire backup/restore time while still maintaining consistency of the backed up data.

An example method for context aware data backup may include determining a first set of files that are altered during normal operation of a computer system and storing the first set of files at a destination location. The method may include determining a second set of files that are altered during normal operation of the computer system and determining a size difference between the first set of files and the second set of files. The method may also include determining a time difference between a first time taken to copy the first set of files and a second time taken to copy a previous set of files to the destination location. The method may include determining that the size difference and the time difference meet a threshold for backup and storing the second set of files at the destination location.

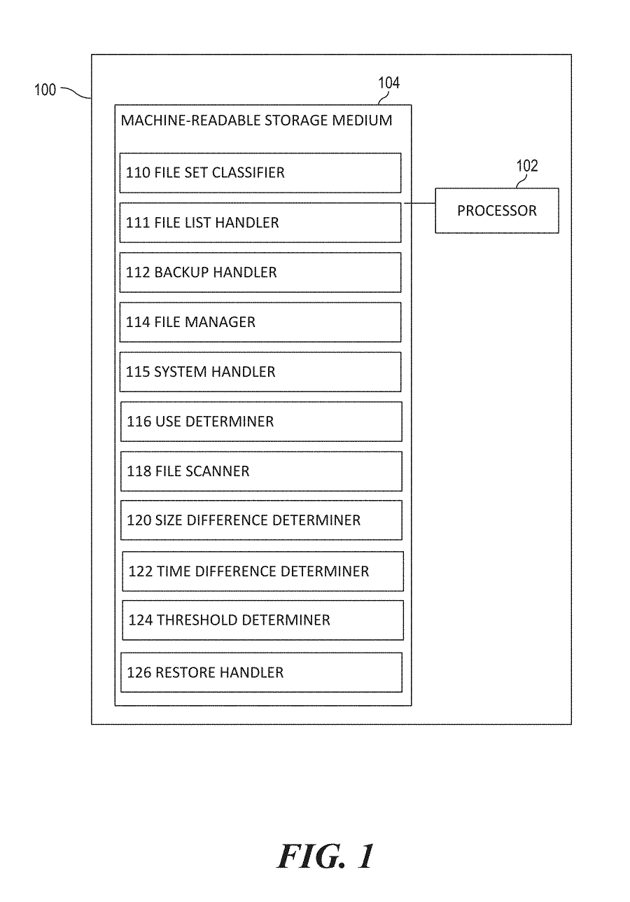

FIG. 1 is a block diagram of an example system 100 for context aware data backup. System 100 may include a processor 102 and a memory 104 that may be coupled to each other through a communication link (e.g., a bus). Processor 102 may include a Central Processing Unit (CPU) or another suitable processor. In some examples, memory 104 stores machine readable instructions executed by processor 102 for operating system 100. Memory 104 may include any suitable combination of volatile and/or non-volatile memory, such as combinations of Random Access Memory (RAM), Read-Only Memory (ROM), flash memory, and/or other suitable memory. Memory 104 may also include a random access non-volatile memory that can retain content when the power is off.

Memory 104 stores instructions to be executed by processor 102 including instructions for file set classifier 110, file list handler 111, backup handler 112, file manager 114, system handler 115, use determiner 116, file scanner 118, size difference determiner 120, time difference determiner 122, threshold determiner 124, restore handler 126 and/or other components. According to various implementations, context aware backup system 100 may be implemented in hardware and/or a combination of hardware and programming that configures hardware. Furthermore, in FIG. 1 and other Figures described herein, different numbers of components or entities than depicted may be used.

Processor 102 may execute instructions of file set classifier 110 to classify files and/or other types of data used in a computer system into sets. The sets may include files that are not altered during normal operation of the computer system, files that are altered during normal operation of the computer system and the files that change when the computer system is shut down. File set classifier 110 may determine a first set of files that are altered during normal operation of a computer system. File set classifier 110 may record environment and configuration items used during normal operation the computer system, during a restore and of the computer system, during an upgrade of the computer system, during startup of the computer system, etc.

File set classifier 110 may determine a set that a file belongs to by comparing the file to a list of known files, selecting files in particular critical folders/directories/location, determining whether the file is used by a particular service, software application, software installation of the computer system, etc. The files may include registry files, configuration files, system files, folders, directories, etc. Files that are altered during normal operation of a computer system may include files that are used for operation of the system, files that are used for operation of a particular software application/installation executing on the system, files that could change during operation of the computer system, files that do change during operation of the computer system. File set classifier 110 may mark a metadata of each file in the first set of files to indicate that the file is one that is altered during normal operation of the system. A data set, such as the first data set, may comprise a collection of data (including the first data) that may be related through ownership or structure. The computer system may be part of a cluster of computer systems.

Processor 102 may execute instructions of file list handler 111 may record one or more of these files in a file list. For example, file list handler 111 may create a file list including files used during startup of the computer system. The file list may be “backed up.” As used herein, backup refers to copying, transferring and/or archiving data from a memory of the computer system and storing the data at a destination location. Upon completion of a backup, file list handler 111 may determine that each file in the file list has been successfully copied to the destination location.

Processor 102 may execute instructions of backup handler 112 to perform a backup on the set of files that are not altered during normal operation of the computer system. Backup handler 112 may further perform a checksum at the source at the source before the backup and at a destination location of the backup after completion of the backup. A checksum operation counts a number of bits in data in an original location (i.e. the memory of the computer system) and at the destination location and compares the numbers to determine whether the same number of bits arrived at the destination location, and hence the backup was successful. If the checksum fails, another backup may be performed.

Backup handler 112 may also identify each file in the set of files that change when the computer system is shut down and back up these files as part of the shutdown of the computer system. Backup handler 112 may further perform a checksum at the source at the source before the backup and at a destination location of the backup after completion of the backup. If the checksum fails, another backup may be performed.

Processor 102 may execute instructions of file manager 114 to identify each file in the first set of files that is altered during normal operation of a computer system and add each of these files to a to-be copied list. File manager 114 may further calculate a total size of the files and/or order the to-be copied list from oldest to newest. File manager 114 may order the to-be copied list using a timestamp of the file, information in the metadata of the file an internal numbering system, etc.

Processor 102 may execute instructions of backup handler 112 to back up the files in the first set of files to a destination location. The files in the first set of files may be copied from oldest to newest. Backup handler 112 may further perform a checksum at the source before the backup and at a destination location of the backup after completion of the backup. If the checksum fails, another backup may be performed. Backup handler 112 may further record the time for the backup and store the time on a memory of the computer system and/or of a destination location of the backup. The time may be recorded in metadata, time stamps, etc. Processor 102 may execute instructions of system handler 115 to pause and/or stop system processes and/or software applications/installations in part or in full during the backup. Backup handler 112 may store the files in the first set of files at the destination location.

Processor 102 may execute instructions of use determiner 116 to determine that a file in the first set of files is currently in use. A file may be used by the computer system, a software application/installation executing on the computer system, etc. If the use determiner 116 determines that a file is in use, the backup of the file may be skipped by the backup handler 112 and the file copier may proceed to back up the next file in the first set of files. Use determiner 116 may add the file that is in use to a second set of files that are altered during normal operation of the computer system. The second set of files may be copied at a later time. The files in the second set of files may be copied from oldest to newest.

After each file in the first set of files that are altered during normal operation of a computer system is considered, such as by being backed up (i.e. as discussed above in reference to backup handler 112) or skipped and added to the second set of files (i.e. as discussed above in reference to use determiner 116), processor 102 may execute instructions of file scanner 118 to scan the computer system for files created and/or modified after the first set of files has been backed up. File scanner 118 may scan each of the files used by the computer system (i.e. as discussed above in reference to file set classifier 110) and determine if each of the files has been considered in some way. File scanner 118 may add the files created and/or modified to the second set of files. Once file scanner 118 has determined that each file in the first set of files has been considered, the first set of files may be replace by the second set of files. Backup handler 112 may determine the total size of the files in the second set of files.

Processor 102 may execute instructions of size difference determiner 120 to determine a size difference between the first set of files and the second set of files. Size difference determiner 120 may use the file sizes determiner by the file copier as discussed above in reference to backup handler 112. Size difference determiner 120 may further determine whether there is a reduction in size from the second set of files compared to the first set of files. If the size difference determiner 120 determines that there is a reduction in size, size difference determiner 120 may further determine the size reduction. The size reduction may be a percentage, a number, etc.

Processor 102 may execute instructions of time difference determiner 122 to determine a time difference between a first time taken to copy the first set of files and a second time taken to copy a previous set of files to the destination location. Time difference determiner 122 may analyze time records, time stamps, etc. on a memory of the computer system and/or the destination location to determine the first and the second time (as discussed herein in regards to backup handler 112). Time difference determiner 122 may compare the time. Time difference determiner 122 may further determine whether there is a reduction in time for the backup for the first set of files as compared to a previous backup performed on the computer system. If the time difference determiner 122 determines that there is a reduction in time, time difference determiner 122 may further determine the time reduction. The time reduction may be a percentage, a number, etc.

Processor 102 may execute instructions of threshold determiner 124 to determine that the size difference and the time difference meet a threshold for backup. If the threshold is met, a backup of the second set of files may be performed. Specifically, backup handler 112 may copy the second set of files to the destination location and store the second set of files at the destination location. The files in the second set of files may be copied from oldest to newest. Processor 102 may execute instructions of system handler 115 to pause and/or stop system processes and/or software applications/installations in part or in full during the backup. The threshold may include a reduction in the size of the first set of files as compared to the second set of files, a reduction between the first time and the second time and/or the first time. The threshold may further include an absolute value for the first time. An example absolute time may be 30 minutes. Of course these are only example threshold values and the percentage values and time interval may be altered based on the configuration and/or purpose of the computer system.

Determining that the size difference and the time difference meet the threshold for backup may be used may the threshold determiner 124 to decide if a backup is computational efficient. For example, if only a small amount of files are in the second set of files, than it may not be computationally efficient to perform the back up. Specifically, it may not be efficient to stop or pause the computer system during the backup (as discussed herein in reference to system handler 115), to only back up a small number of files. As another example, a backup may not be computationally efficient if the time savings is not sufficient as compared to the previous backup. An example threshold that may be used is a fifteen percent reduction in the size of the first set as compared to the second set, a twenty percent reduction in the first time as compared to the second time. The determination of whether the backup may be computationally efficient may be based on the various aspects of the computer system, such as the purpose, allowable downtime, configuration, etc.

Example system 100 for context aware data backup may also be used to restore the backed up files. Processor 102 may execute instructions of restore handler 126 to classify files to be restored into groups. Example groups include files used for system startup and/or upgrade, files not used during system startup and/or upgrade, etc.

For the group of files used for system startup and/or upgrade, restore handler 126 may perform a computer system environment and/or computer system configuration analysis based on data recorded during the backup (e.g. as discussed herein in reference to file set classifier 110). The data recorded during the backup may be used to ensure that the computer system is compatible for the system restore/upgrade. Restore handler 126 may also use the file list (e.g. as discussed herein in reference to file list handler 111) to copy files to a restore system and store the files at the restore system. Restore handler 126 may perform a checksum operation on the copied files.

For the group of files not used for system startup and/or upgrade, restore handler 126 may copy the files to the restore system while the system is running, during the computer system upgrade/restore, after the computer system upgrade/restore has completed, etc. Restore handler 126 may restore these files in the order of greatest likelihood of immediate access by the computer system, software application/installation, etc. Restore handler 126 may determine the likelihood of immediate access by analyzing metadata, file logs, etc. or how often the files were accessed, edited, etc. Restore handler 126 may determine the likelihood of immediate access by bringing restore with the most current file and moving backwards to the oldest files.

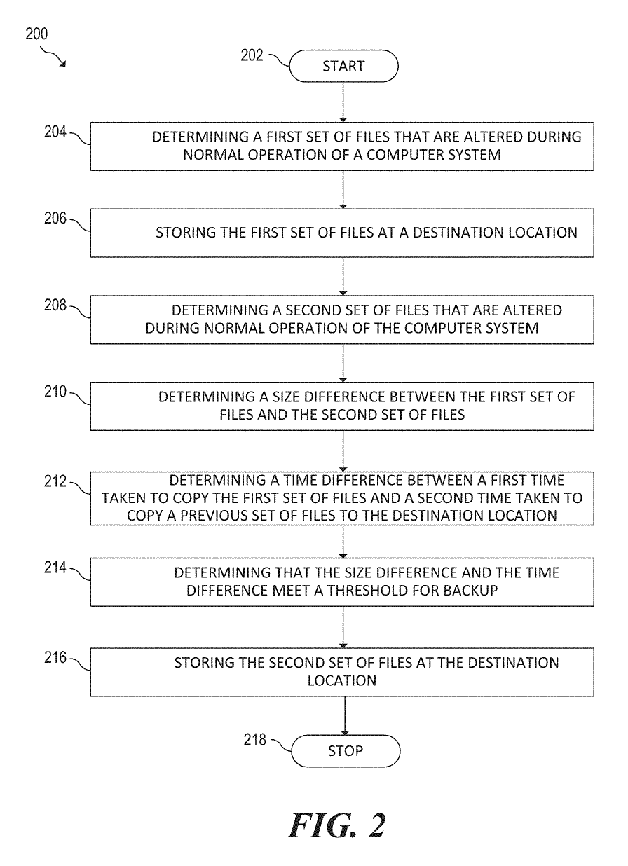

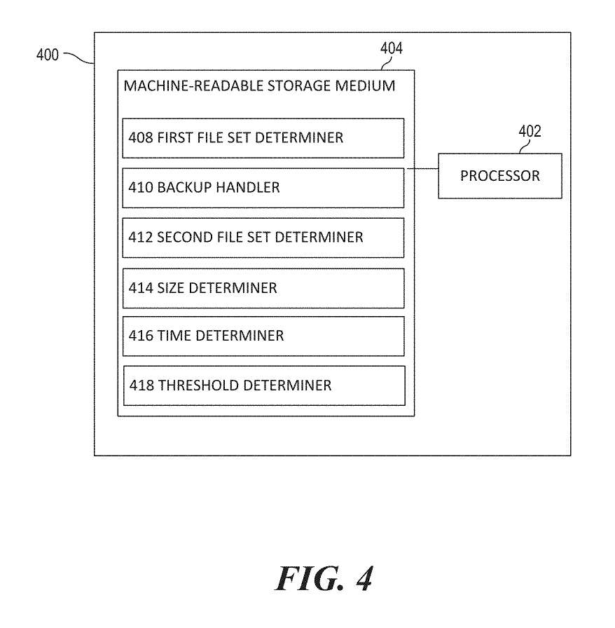

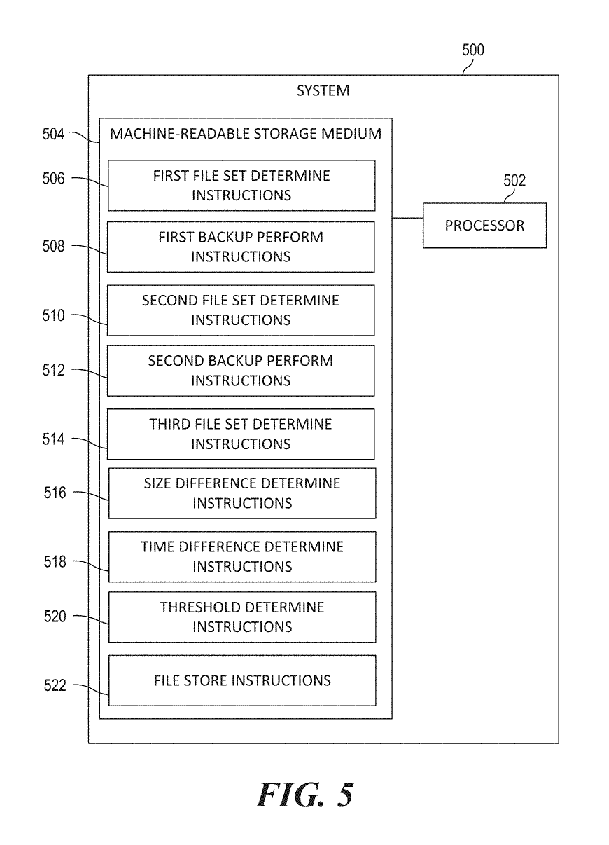

FIG. 2 is a flowchart of an example method 200 for context aware data backup. Method 200 may be described below as being executed or performed by a system, for example, system 100 of FIG. 1, system 400 of FIG. 4 or system 500 of FIG. 5. Other suitable systems and/or computing devices may be used as well. Method 200 may be implemented in the form of executable instructions stored on at least one machine-readable storage medium of the system and executed by at least one processor of the system. The machine-readable storage medium may be non-transitory. Method 200 may be implemented in the form of electronic circuitry (e.g., hardware). At least one block of method 200 may be executed substantially concurrently or in a different order than shown in FIG. 2. Method 200 may include more or less blocks than are shown in FIG. 2. Some of the blocks of method 200 may, at certain times, be ongoing and/or may repeat.

Method 200 may start at block 202 and continue to block 204, where the method may include determining a first set of files that are altered during normal operation of a computer system. The files may include registry files, configuration files, system files, folders, directories, etc. Each file in the first set of files may be sorted from oldest to newest. At block 206, the method may include storing the first set of files at a destination location. The files in the first set of files may be copied from oldest to newest. At block 208, the method may include determining a second set of files that are altered during normal operation of the computer system. The second set of files may include files from the first set that were unable to be copied. Each file in the second set of files may be sorted from oldest to newest. At block 210, the method may include determining a size difference between the first set of files and the second set of files. The size difference may be a reduction in size. At block 212, the method may include determining a time difference between a first time taken to copy the first set of files and a second time taken to copy a previous set of files to the destination location. The time difference may be a reduction in time. At block 214, the method may include determining that the size difference and the time difference meet a threshold for backup. The threshold may include a reduction in the size of the first set of files as compared to the second set of files and a reduction between the first time and the second time. The threshold may also include the first time. At block 216, the method may include storing the second set of files at the destination location. The files in the second set of files may be copied from oldest to newest. Method 200 may eventually continue to block 218, where method 200 may stop.

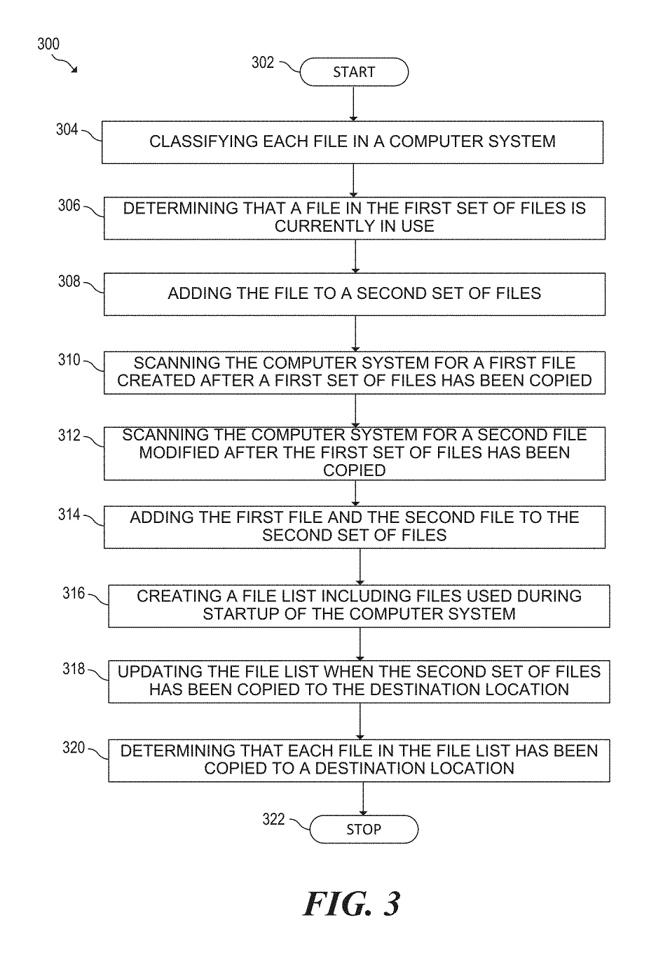

FIG. 3 is a flowchart of an example method 300 for determining files for backup. Method 300 may be described below as being executed or performed by a system, for example, system 100 of FIG. 1, system 400 of FIG. 4 or system 500 of FIG. 5. Other suitable systems and/or computing devices may be used as well. Method 300 may be implemented in the form of executable instructions stored on at least one machine-readable storage medium of the system and executed by at least one processor of the system. The machine-readable storage medium may be non-transitory. Method 300 may be implemented in the form of electronic circuitry (e.g., hardware). At least one block of method 300 may be executed substantially concurrently or in a different order than shown in FIG. 3. Method 300 may include more or less blocks than are shown in FIG. 3. Some of the blocks of method 300 may, at certain times, be ongoing and/or may repeat.

Method 300 may start at block 302 and continue to block 304, where the method may include classifying each file in a computer system. The files may be classified into sets, including a set of files that are altered during normal operation of the computer system, a set of files that are not altered during normal operation of the computer system and a set of files that are altered when the computer system shuts down. At block 306, the method may include determining that a file in the first set of files is currently in use. At block 308, the method may adding the file to the second set of files. At block 310, the method may include scanning the computer system for a first file created after the first set of files has been copied. At block 312, the method may include scanning the computer system for a second file modified after the first set of files has been copied. At block 314, the method may include adding the first file and the second file to the second set of files. At block 316, the method may include creating a file list including files used during startup of the computer system. At block 318, the method may include updating the file list when the second set of files has been copied to the destination location. At block 320, the method may include determining that each file in the file list has been copied to the destination location. Method 300 may eventually continue to block 322, where method 300 may stop.

FIG. 4 is a block diagram of an example system 400 for context aware data backup. System 400 may include a processor 402 and a memory 404 that may be coupled to each other through a communication link (e.g., a bus). Processor 402 may include a Central Processing Unit (CPU) or another suitable processor. In some examples, memory 404 stores machine readable instructions executed by processor 402 for operating system 400. Memory 404 may include any suitable combination of volatile and/or non-volatile memory, such as combinations of Random Access Memory (RAM), Read-Only Memory (ROM), flash memory, and/or other suitable memory.

Memory 404 stores instructions to be executed by processor 402 including instructions for a first file set determiner 408, a backup handler 410, a second file set determiner 412, a size determiner 414, a time determiner 416 and a threshold determiner 418. The components of system 400 may be implemented in the form of executable instructions stored on at least one machine-readable storage medium of system 400 and executed by at least one processor of system 400. The machine-readable storage medium may be non-transitory. Each of the components of system 400 may be implemented in the form of at least one hardware device including electronic circuitry for implementing the functionality of the component.

Processor 402 may execute instructions of first file set determiner 408 to determine a first set of files that are changed while a software application is running. The files may include registry files, configuration files, system files, folders, directories, etc. Each file in the first set of files may be sorted from oldest to newest. Processor 402 may execute instructions of backup handler 410 to perform a first backup on the first set of files. The files in the first set of files may be copied from oldest to newest. Processor 402 may execute instructions of second file set determiner 412 to determine a second set of files including each file belonging to the first set of files that has been modified after the backup. Each file in the second set of files may be sorted from oldest to newest. Processor 402 may execute instructions of size determiner 414 to determine a size difference between the first set of files and the second set of files. The size difference may be a reduction in size. Processor 402 may execute instructions of time determiner 416 to determine a time difference between a first time taken to copy the first set of files and a second time taken to copy a previous set of files to the destination location. The time difference may be a reduction in time. Processor 402 may execute instructions of threshold determiner 418 to determine that the size difference and the time difference meet a threshold for backup. The threshold may include a reduction in the size of the first set of files as compared to the second set of files and a reduction between the first time and the second time. The threshold may also include the first time. Processor 402 may further execute instructions of backup handler 410 further to perform a second backup on the second set of files. The files in the second set of files may be copied from oldest to newest.

FIG. 5 is a block diagram of an example system 500 for context aware data backup. System 500 may be similar to system 100 of FIG. 1, for example. In the example illustrated in FIG. 5, system 500 includes a processor 502 and a machine-readable storage medium 504. Although the following descriptions refer to a single processor and a single machine-readable storage medium, the descriptions may also apply to a system with multiple processors and multiple machine-readable storage mediums. In such examples, the instructions may be distributed (e.g., stored) across multiple machine-readable storage mediums and the instructions may be distributed (e.g., executed by) across multiple processors.

Processor 502 may be at least one central processing unit (CPU), microprocessor, and/or other hardware devices suitable for retrieval and execution of instructions stored in machine-readable storage medium 504. In the example illustrated in FIG. 5, processor 502 may fetch, decode, and execute instructions 506, 508, 510, 512, 514, 516, 518, 520 and 522 to perform context aware data backup. Processor 502 may include at least one electronic circuit comprising a number of electronic components for performing the functionality of at least one of the instructions in machine-readable storage medium 504. With respect to the executable instruction representations (e.g., boxes) described and shown herein, it should be understood that part or all of the executable instructions and/or electronic circuits included within one box may be included in a different box shown in the figures or in a different box not shown.

Machine-readable storage medium 504 may be any electronic, magnetic, optical, or other physical storage device that stores executable instructions. Thus, machine-readable storage medium 504 may be, for example, Random Access Memory (RAM), an Electrically-Erasable Programmable Read-Only Memory (EEPROM), a storage drive, an optical disc, and the like. Machine-readable storage medium 504 may be disposed within system 500, as shown in FIG. 5. In this situation, the executable instructions may be “installed” on the system 500. Machine-readable storage medium 504 may be a portable, external or remote storage medium, for example, that allows system 500 to download the instructions from the portable/external/remote storage medium. In this situation, the executable instructions may be part of an “installation package”. As described herein, machine-readable storage medium 504 may be encoded with executable instructions for context aware data backup. The machine-readable storage medium may be non-transitory.

Referring to FIG. 5, first file set determine instructions 506, when executed by a processor (e.g., 502), may cause system 500 to determine a first set of files that are altered during normal operation of the system. The files may include registry files, configuration files, system files, folders, directories, etc. Each file in the first set of files may be sorted from oldest to newest. First backup perform instructions 508, when executed by a processor (e.g., 502), may cause system 500 to perform a first backup of the first set of files while pausing normal system processes. The files may be backed up from oldest to newest. Second file set determine instructions 510, when executed by a processor (e.g., 502), may cause system 500 to determine a second set of files that are not altered during normal operation of the system. Each file in the second set of files may be sorted from oldest to newest. Second backup perform instructions 512, when executed by a processor (e.g., 502), may cause system 500 to perform a second backup of the second set of files without pausing normal system processes. The files may be backed up from oldest to newest.

Third file set determine instructions 514, when executed by a processor (e.g., 502), may cause system 500 to determine a third set of files including each file belonging to the first set of files that has been modified after the first backup. Each file in the third set of files may be sorted from oldest to newest. Size difference determine instructions 516, when executed by a processor (e.g., 502), may cause system 500 to determine a size difference between the first set of files and the third set of files. The size difference may be a reduction in size. Time difference determine instructions 518, when executed by a processor (e.g., 502), may cause system 500 to determine a time difference between a first time taken to copy the first set of files and a second time taken to copy a previous set of files to the destination location. The time difference may be a reduction in time. Threshold determine instructions 520, when executed by a processor (e.g., 502), may cause system 500 to determine that the size difference and the time difference meet a threshold for backup. The threshold may include a reduction in the size of the first set of files as compared to the second set of files and a reduction between the first time and the second time. The threshold may also include the first time. File copy instructions 522, when executed by a processor (e.g., 502), may cause system 500 to copy the third set of files to the destination location and store the third set of files at the destination location. The files in the third set of files may be copied from oldest to newest.

The foregoing disclosure describes a number of examples for context aware data backup. The disclosed examples may include systems, devices, computer-readable storage media, and methods for context aware data backup. For purposes of explanation, certain examples are described with reference to the components illustrated in FIGS. 1-5. The functionality of the illustrated components may overlap, however, and may be present in a fewer or greater number of elements and components. Further, all or part of the functionality of illustrated elements may co-exist or be distributed among several geographically dispersed locations. Further, the disclosed examples may be implemented in various environments and are not limited to the illustrated examples.

Further, the sequence of operations described in connection with FIGS. 1-5 are examples and are not intended to be limiting. Additional or fewer operations or combinations of operations may be used or may vary without departing from the scope of the disclosed examples. Furthermore, implementations consistent with the disclosed examples need not perform the sequence of operations in any particular order. Thus, the present disclosure merely sets forth possible examples of implementations, and many variations and modifications may be made to the described examples.

1) A method comprising:
determining a first set of files that are altered during normal operation of a computer system;
storing the first set of files at a destination location;
determining a second set of files that are altered during normal operation of the computer system;
determining a size difference between the first set of files and the second set of files;
determining a time difference between a first time taken to copy the first set of files and a second time taken to copy a previous set of files to the destination location;
determining that the size difference and the time difference meet a threshold for backup; and
storing the second set of files at the destination location.

2) The method of claim 1 further comprising:
determining that a file in the first set of files is currently in use; and
adding the file to the second set of files.

3) The method of claim 1 wherein each file in the first set of files is sorted from oldest to newest and the files are copied from oldest to newest.

4) The method of claim 1 further comprising:
scanning the computer system for a first file created after the first set of files has been copied;
scanning the computer system for a second file modified after the first set of files has been copied; and
adding the first file and the second file to the second set of files.

5) The method of claim 1 further comprising;
classifying each file in the computer system into one of: a set of files that are altered during normal operation of the computer system; a set of files that are not altered during normal operation of the computer system; or a set of files that are altered when the computer system shuts down.

6) The method of claim 1 wherein the threshold includes a reduction in the size of the second set of files as compared to the first set of files and a time reduction between the first time and the second time.

7) The method of claim 1 further comprising;
creating a file list including files used during startup of the computer system; and
updating the file list when the second set of files has been copied to the destination location.

8) The method of claim 7 further comprising;
determining that each file in the file list has been copied to the destination location.

9) A system comprising:
a first file set determiner to determine a first set of files that are changed while a software application is running;
a backup handler to perform a first backup on the first set of files;
a second file set determiner to determine a second set of files including each file belonging to the first set of files that has been modified after the backup;
a size determiner to determine a size difference between the first set of files and the second set of files;
a time determiner to determine a time difference between a first time taken to copy the first set of files and a second time taken to copy a previous set of files to the destination location;
a threshold determiner to determine that the size difference and the time difference meet a threshold for backup; and
the backup handler further to perform a second backup on the second set of files.

10) The system of claim 9 further comprising:
a file scanner to scan the computer system for a first file created after the first backup; and
a file set adjuster to add the first file to the second set of files.

11) The system of claim 9 further comprising:
a system handler to stop system processes during the first backup and the second backup.

12) The system of claim 9 further comprising:
a file list creator to create a file list including files used during startup of the computer system; and
a file list updater to update the file list when the second backup is completed.

13) A non-transitory machine-readable storage medium encoded with instructions, the instructions executable by a processor of a system to cause the system to:
determine a first set of files that are altered during normal operation of the system;
perform a first backup of the first set of files while pausing normal system processes;
determine a second set of files that are not altered during normal operation of the system;
perform a second backup of the second set of files without pausing normal system processes;
determine a third set of files including each file belonging to the first set of files that has been modified after the first backup;
determine a size difference between the first set of files and the third set of files;
determine a time difference between a first time taken to copy the first set of files and a second time taken to copy a previous set of files to the destination location;
determine that the size difference and the time difference meet a threshold for backup; and
store the third set of files at the destination location.

14) The non-transitory machine-readable storage medium of claim 13, wherein the instructions executable by the processor of the system further cause the system to:
determine a fourth set of files that are altered when the system shuts down; and
back up the fourth set of files during shutdown of the system.

15) The non-transitory machine-readable storage medium of claim 13, wherein the instructions executable by the processor of the system further cause the system to:
scan the computer system for a first file created after the first set of files has been copied;
scan the computer system for a second file modified after the first set of files has been copied; and
add the first file and the second file to the second set of files.
